(19) United States
(12) Patent Application Publication
(10) Pub. No.: US 2025/0030351 A1
(43) Pub. Date: Jan. 23, 2025

(54) Synchronous Rectification Controller and Control Method Thereof

(71) Applicant: Leadtrend Technology Corporation, Zhubei City (TW)

(72) Inventors: Tsung-Chien WU, Zhubei City (TW); Jun-Hao HUANG, Zhubei City (TW); Chung-Wei LIN, Zhubei City (TW); Ming-Chang TSOU, Zhubei City (TW)

(21) Appl. No.: 18/636,740

(22) Filed: Apr. 16, 2024

(30) Foreign Application Priority Data
Jul. 19, 2023 (TW) 112126895

(51) Int. Cl. H02M 3/335

(52) U.S. Cl. CPC H02M 3/33592

(57) ABSTRACT

Disclosed is the source active region.

### CROSS-REFERENCE TO RELATED APPLICATION

This application claims priority to and the benefit of Taiwan Application Series Number 112126895 filed on Jul. 19, 2023, which is incorporated by reference in its entirety.

### BACKGROUND

The present disclosure relates generally to synchronous rectification, and more particularly to control methods and apparatuses that precharge a control signal at a control terminal of a synchronous rectifier.

Synchronous rectification is a technology that uses actively controlled electronic switches, such as power MOSFETs or bipolar transistors, to replace diodes for rectification, in order to improve power supply efficiency. In conventional semiconductor diodes, the voltage drop is substantially at around 0.5 to 1V, and within the operating current range, this voltage drop does not vary significantly with the current. In contrast, the voltage drop across an actively controlled synchronous rectifier behaves more like a resistor, resulting in a tiny voltage drop at low currents.

The timing of switching ON and OFF a synchronous rectifier needs careful control. If the turning-on of a synchronous rectifier occurs too early, it may lead to the occurrence of reverse current, significantly reducing power supply efficiency. Conversely, if the turn-on happens too late, the majority of the current may flow through a body diode of the synchronous rectifier for example, losing the primary purpose of synchronous rectification.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 illustrates a flyback power supply implemented according to embodiments of the present invention;

FIG. 2 illustrates the SR controller shown in FIG. 1;

FIG. 3 illustrates a control method used for the SR controller in FIG. 2;

FIG. 4 shows some signal waveforms in FIGS. 1 and 2 from moment t₁₀ to moment t_{1E} within switching cycle TCYC₁; and

FIG. 5 illustrates switching cycle T_{CYC2} from moment t₂₀ to moment t₃₀, as well as switching cycle T_{CYC3} from moment t₃₀ to moment t_{3E}.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

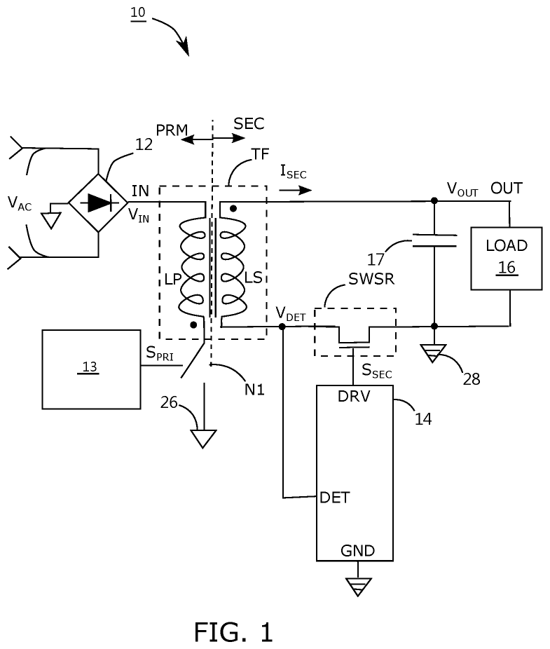

FIG. 1 illustrates flyback power supply 10 implemented according to embodiments of the present invention, serving as an isolated AC to DC power converter for converting AC power source VAC on primary side PRM into DC output power source VOUT on secondary side SEC. Flyback power supply 10 is just one embodiment of the present invention and is not intended to limit the invention. For example, embodiments of the present invention can also include LLC converters, active-clamp flyback power converters (ACF), or asymmetric half-bridge (AHB) power supplies.

In FIG. 1, transformer TF divides flyback power supply 10 into primary side PRM and secondary side SEC. On primary side PRM, bridge rectifier 12 rectifies AC power source VAC, providing input power source VIN on the input power line IN and input ground reference voltage on input ground line 26. Power controller 13 generates pulse-width modulation (PWM) signal S_{PRI} to control power switch N1 and manage the energy storage and release of transformer TF.

As transformer TF stores and releases energy, the induced voltage across secondary winding LS and the induced current I_{SEC} through secondary winding LS as well are generated. Synchronous rectifier SWSR is connected between output ground line 28 and secondary winding LS to rectify induced current I_{SEC}, generally maintaining induced current I_{SE}C not less than OA. Induced current I_{SEC} charges output capacitor 17, establishing DC output power source V_{OUT} on output capacitor 17, supplying power to load 16.

SR controller 14 provides control signal S_{SEC} through control terminal DRV to control synchronous rectifier SWSR. Synchronous rectifier SWSR can provide a channel, with one end connected to output ground line 28 and the other end connected to secondary winding LS. The joint between synchronous rectifier SWSR and secondary winding LS provides detection signal V_{DET}, which is fed back to SR controller 14 through detection terminal DET. Below, the voltage levels on the secondary side SEC are represented in relative voltage terms considering the voltage level at the output ground line 28 as 0V on secondary side SEC. For example, if detection signal V_{DET} is stated as 15V, it means that detection signal V_{DET} is 15V higher than the voltage at output ground line 28.

Synchronous rectifier SWSR in FIG. 1 is an enhancement-mode NMOS transistor characterized with threshold voltage V_{SR_TH}. When control signal S_{SEC} is greater than threshold voltage V_{SR_TH}, synchronous rectifier SWSR provides a channel that is approximately short-circuited, connecting output ground line 28 to secondary winding LS. When control signal S_{SEC} is between 0V and threshold voltage V_{SR_TH}, that channel will approximately become open, isolating output ground line 28 from secondary winding LS.

In the embodiments of the present invention, based on detection signal V_{DET}, SR controller 14 can identify two possible conditions: 1) power switch N1 on primary side PRM has been turned ON for a sufficient duration, and 2) the forward-bias voltage across the channel of synchronous rectifier SWSR is sufficiently large. As long as one of these two conditions occurs, SR controller 14 precharges control terminal DRV to sub-threshold voltage V_{SUB_T}, which is between the threshold voltage VSR_TH and 0V. In this way, synchronous rectifier SWSR can be quickly turned on based on the subsequent changes in detection signal V_{DET}, thereby increasing the efficiency of power conversion.

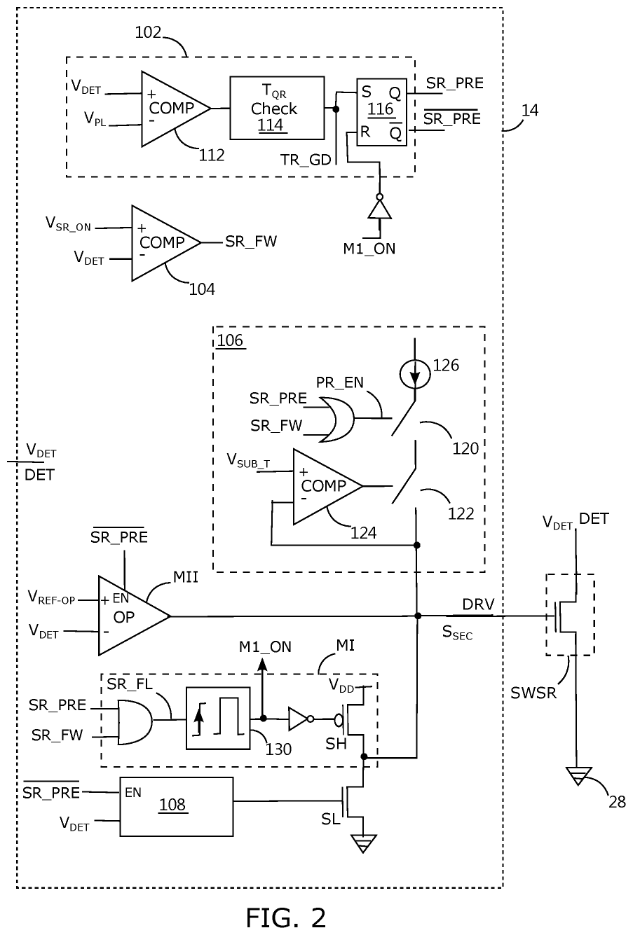

FIG. 2 illustrates SR controller 14 shown in FIG. 1, comprising primary-side ON detector 102, forward-bias voltage detector 104, precharge circuit 106, drivers MI and MII, pull-down controller 108, pull-down switch SL, and some logic controls.

In primary-side ON detector 102, comparator 112 compares detection signal V_{DET} at detection terminal DET with predetermined level V_{PL}, which is 15V for example. Here, the duration during which detection signal V_{DET} is higher than predetermined level V_{PL} is referred to as excitation time T_{PL}. Debounce circuit 114 checks whether excitation time T_{PL} has exceeded preset time T_{QR}. If excitation time T_{PL} is longer than preset time T_{QR}, confirmation signal TR_GD transitions from “0” to “1” in logic; otherwise, it remains “0”. When confirmation signal TR_GD transitions from logic “0” to “1”, it has a rising edge, and satisfaction signal SR_PRE becomes logic “1”. In FIG. 2, register 116 is an SR flipflop as an example. The falling edge of signal M1_ON resets register 116 to make satisfaction signal SR_PRE “0” in logic. Generally speaking, satisfaction signal SR_PRE output by register 116 will be “1” in logic when excitation time T_{PL} has lasted preset time T_{QR}.

Forward-bias voltage detector 104 compares detection signal V_{DET} with ON-reference level V_{SR_ON}, −0.4V for example. When detection signal V_{DET} is below ON-reference level V_{SR_ON}, forward-bias voltage detector 104 sets forward-bias signal SR_FW to “1” in logic, indicating that there is a sufficiently large forward-bias voltage between the two ends of the channel that synchronous rectifier SWSR provides. Otherwise, detection signal V_{DET} is not below ON-reference level V_{SR_ON}, and forward-bias voltage detector 104 sets forward-bias signal SR_FW to “0” in logic.

Precharge circuit 106, based on satisfaction signal SR_PRE and forward-bias signal SR_FW, is used to precharge control signal S_{SEC} at control terminal DRV to sub-threshold voltage V_{SUB_T}, which is between threshold voltage V_{SR_TH} and 0V. For example, threshold voltage V_{SR_TH} is 5V and sub-threshold voltage V_{SUB_T} is 2.5V. As shown in FIG. 2, current source 126 can charge control terminal DRV through switches 120 and 122 as long as either forward-bias signal SR_FW or satisfaction signal SR_PRE is “1”, quickly raising control signal S_{SEC} up to sub-threshold voltage V_{SUB_T}. Comparator 124 turns ON switch 122 allowing current source 126 to charge control terminal DRV until control signal S_{SEC} is equal to or more than sub-threshold voltage V_{SUB_T}. In other words, comparator 124 stops current source 126 from charging control terminal DRV if control signal S_{SEC} exceeds sub-threshold voltage V_{SUB_T}.

Driver MI includes pull-up switch SH and control circuit 130. Pull-up switch SH is a PMOS transistor for example. When pull-up switch SH is turned on, it can quickly pull up control signal S_{SEC} to constant ON voltage VDD, which for example is an operating power supply voltage. Forward-bias signal SR_FW and satisfaction signal SR_PRE, through an AND gate, can trigger control circuit 130 to turn on pull-up switch SH. Control circuit 130 in FIG. 2 is a pulse generator for example. From the analysis of FIG. 2, when both forward-bias signal SR_FW and satisfaction signal SR_PRE are “1” in logic, control circuit 130 provide signal M1_ON having a pulse with a preset pulse width, to turn on pull-up switch SH for a predetermined time.

FIG. 2 shows that driver MII is an operational amplifier, comparing detection signal V_{DET} with default reference level V_{REF_OP} to adjust control signal S_{SEC}. Driver MII is used to approximately regulate detection signal V_{DET} at default reference level V_{REF_OP}. In one embodiment, both default reference level V_{REF_OP} and ON-reference level V_{SR_ON} are −0.4V. In another embodiment, default reference level V_{REF_OP} is −0.5V, and ON-reference level V_{SR_ON} is −0.4V. When satisfaction signal SR_PRE output by register 116 is “1”, driver MII is disabled, and its output becomes high impedance.

Pull-down controller 108 can turn ON pull-down switch SL to quickly pull control signal S_{SEC} down to 0V, effectively turning off synchronous rectifier SWSR and preventing induced current I_{SEC} from becoming negative. For example, pull-down controller 108 compares detection signal V_{DET} with 0V, the ground reference voltage at output ground line 28. When detection signal V_{DET} is higher than 0V, pull-down controller 108 turns ON pull-down switch SL, clamping control signal S_{SEC} to 0V. When satisfaction signal SR_PRE is logic “1”, pull-down controller 108 is disabled and keeps pull-down switch SL OFF.

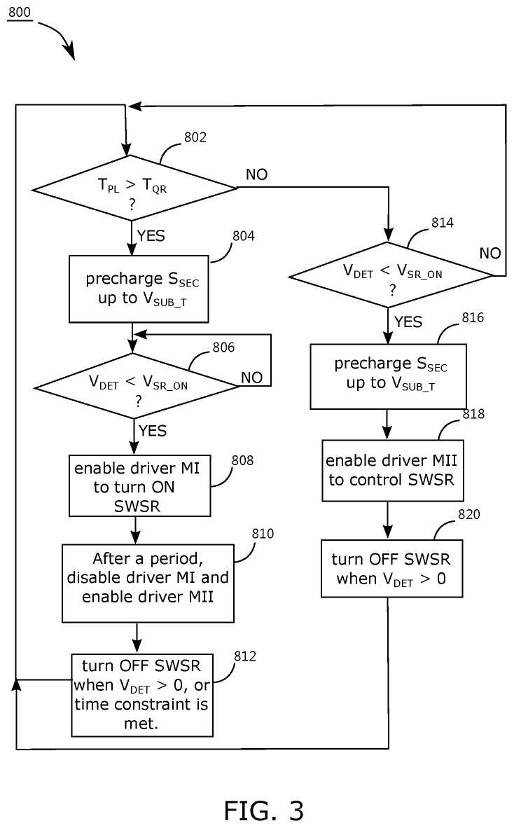

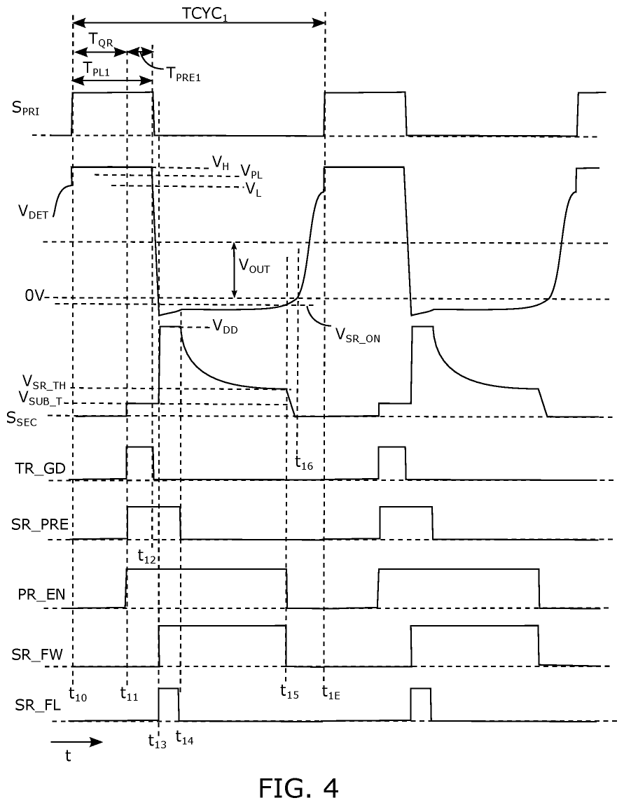

FIG. 3 illustrates control method 800 used for SR controller 14 in FIG. 2. FIG. 4 shows some signal waveforms in FIGS. 1 and 2 from moment t₁₀ to moment t_{1E} within switching cycle TCYC₁. FIG. 4, from top to bottom, has PWM signal S_{PRI} controlling power switch N1, detection signal V_{DET}, control signal S_{SEC} for controlling synchronous rectifier SWSR, confirmation signal TR_GD output by debounce circuit 114, satisfaction signal SR_PRE output by register 116, precharge signal PR_EN within precharge circuit 106, forward-bias signal SR_FW output by forward-bias voltage detector 104, and fully-ON signal SR_FL that driver MI provides to control circuit 130.

Step 802 of FIG. 3 checks whether excitation time T_{PL} has lasted preset time T_{QR}. Referring to FIG. 4, at moment t₁₀, PWM signal S_{PRI} starts to turn on power switch N1. Due to inductive coupling of transformer TF, detection signal V_{DET} rises to high voltage level V_{H} at time t₁₀, exceeding predetermined level V_{PL}. At moment t₁₀, comparator 112 in FIG. 2, in response to detection signal V_{DET} exceeding predetermined level V_{PL}, indicates the beginning of excitation time T_{PL1}. At moment t₁₁, debounce circuit 114 in FIG. 2 detects that excitation time T_{PL}, has lasted preset time T_{QR}. Therefore, confirmation signal TR_GD turns from “0” to “1” in logic, causing both satisfaction signal SR_PRE and precharge signal PR_EN to transition to “1” in logic, as illustrated in FIG. 4.

When satisfaction signal SR_PRE is “1”, both driver MII and pull-down controller 108 in FIG. 2 are disabled, not to clamp control signal S_{SEC} down to 0V.

When the result of step 802 of FIG. 3 is affirmative, step 804 proceeds to precharge control signal S_{SEC} up to sub-threshold voltage V_{SUB_T}. Precharge time T_{PRE1}, the time interval from moment t₁₁ to moment t₁₂ in FIG. 4, represents the part when excitation time T_{PL}, exceeds preset time T_{QR}. At moment t₁₁ in FIG. 4, precharge signal PR_EN transitions to “1”, causing precharge circuit 106 to precharge control signal SSEC at control terminal DRV up to sub-threshold voltage V_{SUB_T}, which is between threshold voltage V_{SR_TH} and 0V, as shown in FIG. 4. During precharge time T_{PRE1}, driver MII is disabled, and control signal S_{SEC} is maintained at sub-threshold voltage V_{SUB_T}.

Step 806 of FIG. 3 follows step 804. Forward-bias voltage detector 104 compares detection signal V_{DET} with ON-reference level V_{SR_ON}. Once it is detected that detection signal V_{DET} is below ON-reference level V_{SR_ON}, step 808 begins to enable driver MI to turn ON synchronous rectifier SWSR. At moment t₁₂ in FIG. 4, PWM signal S_{PRI} starts to turn OFF power switch N1, causing detection signal V_{DET} to rapidly drop from high voltage level V_{H} and ending excitation time T_{PL1}. At moment t₁₃ in FIG. 4, detection signal V_{DET} is already below ON-reference level V_{SR_ON}, and fully-ON signal SR_FL transitions to “1”. Driver MI, through control circuit 130, turns ON pull-up switch SH, quickly pulling up control signal S_{SEC} to constant ON voltage V_{DD}.

After driver MI has fully turned ON synchronous rectifier SWSR for a certain period, step 810 disables driver MI and begins to enable driver MII. Control circuit 130, at moment t₁₄, turns OFF pull-up switch SH, and at the same time resets register 116, causing both satisfaction signal SR_PRE and fully-ON signal SR_FL to transition to “0”. Consequently, driver MI is disabled, pull-up switch SH is turned off, and control signal S_{SEC} is no longer pulled up to constant ON voltage V_{DD}. As enabled, driver MII starts to regulate detection signal V_{DET} to default reference level V_{REF}_op. Therefore, control signal S_{SEC} gradually decreases from constant ON voltage V_{DD}, as shown in FIG. 4.

In step 812, when detection signal VDET is greater than 0V or a time constraint is met, pull-down controller 108 in FIG. 2 turns ON pull-down switch SL, fixing control signal S_{SEC} at 0V. At time t₁₅ in FIG. 4, detection signal V_{DET} begins to rise above ON-reference level V_{SR_ON}, and precharge circuit 106 stops clamping control signal S_{SEC}, which continues decreasing as being driven by driver MII. At time t₁₆, detection signal V_{DET} starts to exceed 0V, and accordingly pull-down switch SL is turned ON, fixing control signal S_{SEC} at 0V.

From FIG. 4, it can be observed that after excitation time T_{PL1} exceeds preset time T_{QR}, SR controller 14 can confirm that power switch N1 on primary side PRM has been ON for a sufficient duration, and that synchronous rectifier SWSR can then be prepared to rectify upcoming high current. Accordingly, control signal S_{SEC} is precharged to sub-threshold voltage V_{SUB_T}. This allows control signal S_{SEC} to rise rapidly to constant ON voltage V_{DD} from sub-threshold voltage V_{SUB_T} at subsequent moment t₁₃. This rapid rise enables synchronous rectifier SWSR to be ON quickly, providing a low-impedance channel, which reduces conduction losses significantly. Additionally, at moment t₁₃, synchronous rectifier SWSR is turned ON using driver MI, which quickly raises control signal S_{SEC} to constant ON voltage V_{DD}, further reducing the channel impedance of synchronous rectifier SWSR.

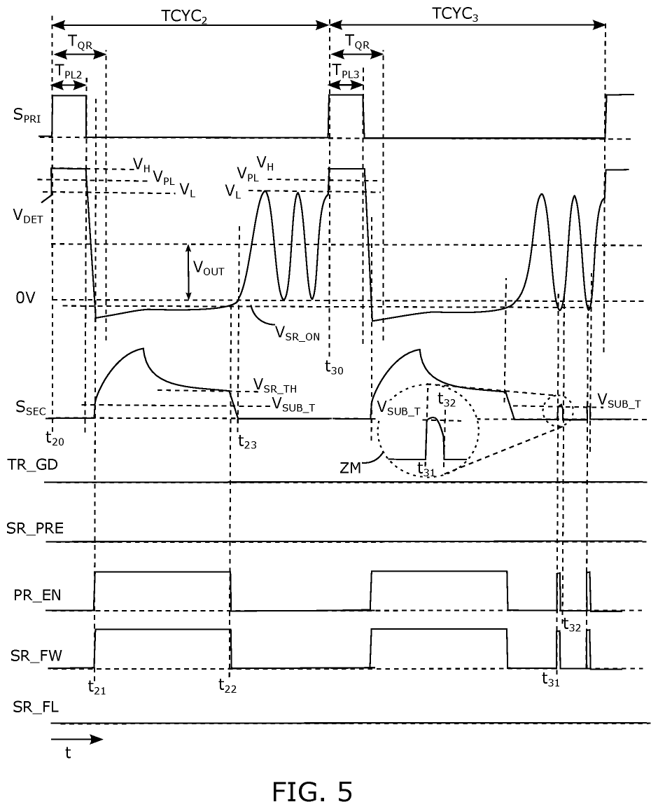

FIG. 5 illustrates switching cycle T_{CYC2} from moment t₂₀ to moment t₃₀, as well as switching cycle T_{CYC3} from moment t₃₀ to moment t_{3E}, along with some signal waveforms. Portions of FIG. 5 are similar to or the same with FIG. 4 which has been explained previously, so they will not be reiterated.

As shown in FIG. 5, predetermined level V_{PL} is between high voltage level V_{H} and low voltage level V_{L}. High voltage level V_{H} is approximately the voltage level reached by detection signal V_{DET} when power switch N1 is turned on. Low voltage level V_{L} is approximately the voltage level of the highest peak that detection signal VDET oscillates to reach after transformer TF completes discharging at moment t₂₃. For example, low voltage level V_{L} is roughly twice the voltage of DC output power source V_{OUT}.

In switching cycle T_{CYC2}, excitation time T_{PL2}, during which detection signal V_{DET} remains above predetermined level V_{PL}, is shorter than preset time T_{QR}. Therefore, debounce circuit 114 in FIG. 2 consistently sets confirmation signal TR_GD to “O”, causing that both satisfaction signal SR_PRE and fully-ON signal SR_FL are “0” throughout entire switching cycle T_{CYC2}. This implies that driver MI is not used to turn on synchronous rectifier SWSR during switching cycle T_{CYC2}. In control method 800 of FIG. 3, the result of step 802 is negative for switching cycle T_{CYC2}, so step 814 follows to check whether detection signal V_{DET} is below the ON-reference level V_{SR_ON}.

At moment t₂₁ in switching cycle TCYC2, detection signal V_{DET} has fallen below ON-reference level V_{SR_ON}, causing precharge circuit 106 to rapidly precharge control signal S_{SEC} to sub-threshold voltage V_{SUB_T} (step 816). Subsequently, driver MII adjusts control signal S_{SEC} based on detection signal V_{DET}, slowly raising or lowering it (step 818), approximately maintaining control signal S_{SEC} above threshold voltage V_{SR_TH}.

At moment t₂₂, detection signal V_{DET} is no longer able to be maintained at ON-reference level V_{SR_ON}. Accordingly, control signal S_{SEC} is pulled down below threshold voltage V_{SR_TH}, and both forward-bias signal SR_FW and precharge signal PR_EN transition to “0” in logic.

At moment t₂₃, as detection signal V_{DET} begins to rise above 0V, pull-down switch SL is turned ON to fix control signal S_{SEC} at 0V (step 820).

Switching cycle T_{CYC3} is generally similar to switching cycle TCYC2, and the details that are the same or similar can be referred to in the previous explanations. What distinguishes switching cycle T_{CYC3} from switching cycle TCYC2 is that at moment t₃₁ within T_{CYC3}, for some reasons, detection signal V_{DET} briefly drops below ON-reference level V_{SR_ON}. Therefore, forward-bias signal SR_FW and precharge signal PR_EN momentarily transition to “1” in logic.

Block ZM in FIG. 5 magnifies control signal S_{SEC} near moment t₃₁. As precharge signal PR_EN transitions to “1”, control signal S_{SEC} is rapidly precharged to sub-threshold voltage V_{SUB_T} at moment t₃₁. At the same time, driver MII also gradually adjusts control signal S_{SEC} based on detection signal V_{DET}. As detection signal V_{DET} rises above 0V at moment t₃₂, pull-down switch SL is turned ON, fixing control signal S_{SEC} at 0V.

In one embodiment, SR controller 14 can timely sample control signal S_{SEC} to determine threshold voltage V_{SR_TH} Of synchronous rectifier SWSR. For example, at moment t₁₅ or t₂₂ in FIGS. 4 and 5 when a falling edge of forward-bias signal SR_FW occurs, SR controller 14 samples control signal S_{SEC} to use as threshold voltage V_{SR_TH}.

SR controller 14 might generate sub-threshold voltage V_{SUB_T} based on threshold voltage V_{SR_TH}. In one embodiment, sub-threshold voltage V_{SUB_T} is proportional to threshold voltage V_{SR_TH}, such as being 0.5 times threshold voltage V_{SR_TH}.

While the invention has been described by way of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method for synchronous rectification in use of a power supply having primary and secondary sides isolated from each other, wherein the power supply includes on the secondary side a synchronous rectifier with a control terminal, at which a control signal turns ON the synchronous rectifier to provide a channel approximately short-circuited if the control signal is greater than a threshold voltage, and turns OFF the synchronous rectifier to turn the channel into an open circuit if the control signal is between the threshold voltage and a ground reference voltage, the control method comprising:
receiving a detection signal generated based on one end of the channel;
comparing the detection signal with a predetermined level, wherein the predetermined level is higher than the ground reference voltage, and an excitation time is a period when the detection signal exceeds the predetermined level;
checking if the excitation time lasts a preset time to generate a satisfaction signal; and
precharging the control signal to a sub-threshold voltage between the threshold voltage and the ground reference voltage in response to the satisfaction signal.

2. The control method of claim 1, further comprising:
providing an operational amplifier to adjust the control signal in response to the detection signal and regulate the detection signal at a default reference level less than the ground reference voltage.

3. The control method of claim 2, further comprising:
disabling the operational amplifier in response to the satisfaction signal.

4. The control method of claim 3, further comprising:
precharging the control signal to the sub-threshold voltage and disabling the operational amplifier after the excitation time lasts the preset time and before the excitation time ends.

5. The control method of claim 2, comprising:
pulling up the control signal to a constant ON voltage higher than the threshold voltage when the detection signal is less than the ON-reference level after the excitation time ends.

6. The control method of claim 5, further comprising:
providing a pull-up switch for pulling up the control signal;
turning OFF the pull-up switch after turning ON the pull-up switch for a predetermined time; and
enabling the operational amplifier to regulate the detection signal at the default reference level after turning OFF the pull-up switch.

7. The control method of claim 1, comprising:
comparing the detection signal and the ground reference voltage; and
turning ON a pull-down switch to clamp the control signal to the ground reference voltage if the detection signal exceeds the ground reference voltage.

8. The control method of claim 1, comprising:
comparing the detection signal with an ON-reference level to generate a forward-bias signal, wherein the ON-reference level is below the ground reference voltage; and
precharging the control signal to the sub-threshold voltage in response to the forward-bias signal.

9. A synchronous rectifier controller in use of a power supply with primary and second sides isolated from each other, wherein on the secondary side the power supply comprises a synchronous rectifier with a control terminal, a control signal at the control terminal turns ON the synchronous rectifier to provide a channel approximately short-circuited if the control signal exceeds a threshold voltage, the control signal substantially turns OFF the synchronous rectifier to turn the channel into an open circuit if the control signal is between the threshold voltage and a ground reference voltage, the synchronous rectifier controller comprising:
a primary-side ON detector, comparing a detection signal at one end of the channel with a predetermined level, wherein the predetermined level is higher than the ground reference voltage, an excitation time is a period when the detection signal exceeds the predetermined level, and the primary-side ON detector provides a satisfaction signal if the excitation time lasts a preset time; and
a precharge circuit precharging the control signal to a sub-threshold voltage between the threshold voltage and the ground reference voltage in response to the satisfaction signal.

10. The synchronous rectifier controller of claim 9, wherein the primary-side ON detector comprises:
a comparator, comparing the detection signal with the predetermined level to detect the excitation time; and
a debounce circuit connected to the comparator, for generating a confirmation signal if the excitation time lasts the preset time; and
a register for recording the conformation signal to generate the satisfaction signal.

11. The synchronous rectifier controller of claim 9, wherein the precharge circuit comprises:
a current source charging the control signal; and
a comparator comparing the control signal with the sub-threshold voltage to control the current source.

12. The synchronous rectifier controller of claim 9, comprising:
a driver for pulling up the control signal, comprising:
a pull-up switch for pulling up the control signal to a constant ON voltage higher than the threshold voltage, so as to turn ON the synchronous rectifier; and
a control circuit for controlling the pull-up switch in response to the satisfaction signal.

13. The synchronous rectifier controller of claim 12, wherein the control circuit is a pulse generator for turning ON the pull-up switch for a predetermined time.

14. The synchronous rectifier controller of claim 9, further comprising
an operational amplifier for driving the control signal to regulate the detection signal at a default reference level less than the ground reference voltage.

15. The synchronous rectifier controller of claim 14, wherein after the excitation time has lasted the preset time and before the excitation time ends, the precharge circuit precharges the control signal to the sub-threshold voltage and the operational amplifier is disabled.

16. The synchronous rectifier controller of claim 9, comprising:
a pull-down switch connected to the control terminal for fixing the control signal at the ground reference voltage; and
a pull-down controller to turn ON the pull-down switch when the detection signal exceeds the ground reference voltage.

17. The synchronous rectifier controller of claim 9, comprising:
a forward-bias voltage detector, for comparing the detection signal with an ON-reference level to generate a forward-bias signal, wherein the ON-reference level is below the ground reference voltage;
wherein, in response to the forward-bias signal, the precharge circuit precharges the control signal to the sub-threshold voltage if the detection signal is less than the ON-reference level.

18. A control method for controlling a synchronous rectifier with a control terminal, at which a control signal turns ON the synchronous rectifier to provide a channel approximately short-circuited if the control signal is greater than a threshold voltage, and turns OFF the synchronous rectifier to turn the channel into an open circuit if the control signal is between the threshold voltage and a ground reference voltage, wherein one end of the channel provides a detection signal, and the other end of the channel provides the ground reference voltage, the control method comprising:
comparing the detection signal with a predetermined level to determine an excitation time, wherein the predetermined level is higher than the ground reference voltage, and the excitation time is a period when the detection signal exceeds the predetermined level;
checking if the excitation time lasts a preset time to generate a satisfaction signal; and
precharging the control signal to a sub-threshold voltage between the threshold voltage and the ground reference voltage in response to the satisfaction signal.

19. The control method of claim 18, further comprising:
providing an operational amplifier to adjust the control signal in response to the detection signal and regulate the detection signal at a default reference level less than the ground reference voltage.

20. The control method of claim 19, further comprising:
disabling the operational amplifier in response to the satisfaction signal and precharging the control signal to the sub-threshold voltage and disabling the operational amplifier after the excitation time lasts the preset time and before the excitation time ends.
